(19) United States
(12) Patent Application Publication
(10) Pub. No.: US 2025/0391623 A1
(43) Pub. Date: Dec. 25, 2025

(54) SECONDARY WIRING DEVICE

(71) Applicant: Chint Low Voltage Electrical Technology Co., Ltd., Songjiang District, Shanghai (CN)

(72) Inventors: Zhigang LU, Songjiang District, Shanghai (CN); Zhibin QIN, Songjiang District, Shanghai (CN); Hongjian LEI, Songjiang District, Shanghai (CN); Na XIN, Songjiang District, Shanghai (CN); Chuancan LIAO, Songjiang District, Shanghai (CN)

(21) Appl. No.: 18/877,866

(22) PCT Filed: Jul. 13, 2023
(86) PCT No.: PCT/CN2023/107100

§ 371 Date: Dec. 20, 2024

(30) Foreign Application Priority Data
Aug. 9, 2022 (CN) 202210949514.6

(51) Int. Cl. H01H 71/02

(52) U.S. Cl. CPC H01H 71/02

(57) ABSTRACT

A secondary wiring device includes a moving wiring assembly and a static wiring assembly. The moving wiring assembly includes a base and a moving part slidably assembled in a base cavity. A first wiring terminal is arranged on the moving part. A locking mechanism is arranged between the base and the moving part. The locking mechanism includes a first locking assembly. The first locking assembly is used for locking the moving part in the base cavity. The first locking assembly includes a first limiting part, a rotating member and a sliding member. When the moving wiring assembly moves from a test position to a connection position, the static wiring assembly drives the rotating member to unlock and rotate. The sliding member is driven by the rotating member to slide in a direction away from the first limiting part so as to release limiting fit, such that the moving part moves in the base cavity. In the present invention, the first locking assembly of the locking mechanism locks the moving part in the base cavity, and the moving part can move in the base cavity after unlocking, achieving the advantages of simple structure, high reliability and convenience in operation.

### TECHNICAL FIELD

The present invention relates to the field of low-voltage electrical appliances, and more particularly to a secondary wiring device.

### BACKGROUND

A drawer-type circuit breaker is a common low-voltage electrical appliance, which is used to distribute electric energy and protect lines and equipment from short circuit, overload, single-phase grounding, under voltage and other faults, and is widely applied in a power distribution system because of its convenience in overhaul and maintenance and other characteristics. A secondary wiring device, as an important component in an accessory system of the drawer-type circuit breaker, usually includes a moving wiring assembly and a static wiring assembly which are in plug-in fit with each other. The moving wiring assembly is pushed and pulled to be switched among a connection position, a test position and a disconnection position. The moving wiring assembly includes a base and a moving part, wherein the moving part needs to be in limiting fit with the base and also needs to be able to slide relative to the base. In this way, it is very necessary to design a locking mechanism which has a simple structure and high reliability and is applicable to the moving part and the base.

### SUMMARY

An object of the present invention is to overcome the defects of the prior art and provide a secondary wiring device. The secondary wiring device has a locking mechanism which has a simple structure and high reliability and is applicable to a moving part and a base.

In order to achieve the above object, the present invention adopts the following technical solutions:

A secondary wiring device, comprising a moving wiring assembly and a static wiring assembly which are in plug-in connection with each other, wherein the moving wiring assembly is provided with a first wiring terminal; the static wiring assembly is provided with a second wiring terminal that is in plug-in fit with the first wiring terminal; the moving wiring assembly moves among a disconnection position, a test position and a connection position, wherein the test position is located between the connection position and the disconnection position; the first wiring terminal is separated from the second wiring terminal at the disconnection position; the first wiring terminal is in electrical contact connection with the second wiring terminal at the test position; the first wiring terminal is in electrical contact connection with the second wiring terminal at the connection position;
the dynamic wiring assembly comprises a base and a moving part that is slidably assembled in a base cavity; the first wiring terminal is arranged on the moving part; a locking mechanism is arranged between the base and the moving part; the locking mechanism includes a first locking assembly; the first locking assembly is used for locking the moving part in the base cavity; and
the first locking assembly comprises a first limiting part, a rotating member and a sliding member, wherein the first limiting part is fixedly arranged on the moving part; the sliding member is slidably assembled on the base and is in limiting fit with the first limiting part; the rotating member is rotatably assembled between the moving part and the base; when the moving wiring assembly moves from the test position to the connection position, the static wiring assembly drives the rotating member to unlock and rotate; and the sliding member is driven by the rotating member to slide in a direction away from the first limiting part so as to release the limiting fit, so that the moving part moves in the base cavity.

Further, the central axis of the first limiting part is parallel to a moving direction of the moving wiring assembly, the rotating member and the sliding member are positioned on both sides of the first limiting part respectively, with the sliding member performing linear reciprocating motion in a direction perpendicular to the central axis of the first limiting part.

Further, the first locking assembly further comprises a first elastic member and a second elastic member which cooperate with the rotating member and the sliding member respectively; when the moving wiring assembly moves from the connection position to the test position, the first elastic member drives the rotating member to lock and rotate, and the second elastic member drives the sliding member to towards the first limiting part.

Further, a first connecting shaft and an abutting part are arranged on one side of the first limiting part in a protruding manner; the rotating member and the first elastic member are sleeved onto the first connecting shaft; one elastic arm of the first elastic member abuts against the abutting part, and the other elastic arm cooperates with the second connecting arm of the rotating member; and the first rotating arm of the rotating member cooperates with the sliding member.

Further, a side wall of the base cavity is provided with a sliding cavity; the sliding member is slidably assembled in the sliding cavity; an assembling hole is formed in the middle of the sliding member; with a second elastic member mounted inside the assembling hole; a boss is arranged on one side of the sliding member in a protruding manner; and the bottom surface of the boss may abut against one side of the first limiting part.

Further, a guide structure is arranged between the moving part and the static wiring assembly; the guide structure comprises a guide part and a guide hole; and as the moving wiring assembly moves, the guide part is in plug-in fit with the guide hole.

Further, one end of the first limiting part facing the static wiring assembly protrudes and extends outward to form the guide part; and the static wiring assembly is provided with the guide hole that cooperates with the guide part.

Further, the locking mechanism further comprises a second locking assembly; the second locking assembly is arranged on a side of the base cavity and/or a side of the moving part; and after the first locking assembly is unlocked, the second locking assembly limits the moving part from moving out of the base cavity.

Further, the moving part comprises an inner shell and a plurality of first wiring terminals assembled side by side in an inner shell cavity; a locking mechanism is arranged between the outer side of the inner shell and the base; the static wiring assembly comprises a pair of cooperation parts and a static wiring base arranged between the pair of cooperation parts; the static wiring base comprises a plurality of second wiring terminals arranged side by side; and at the connection position, the first wiring terminals are in plug-in connection with the second wiring terminals, and the rotating member is driven by the cooperation parts to unlock and rotate.

Further, each first wiring terminal comprises a first housing and at least one first wiring member; each first housing is clamped into the inner shell cavity; two adjacent first wiring terminals are spliced through the first housing; the first wiring member is assembled in the first housing in a limiting manner; and both ends of the first wiring member can pass through the first housing.

Further, a first clamping part is arranged on the upper side and/or lower side of each first housing; a second clamping part is cooperatively arranged on an upper side wall and/or lower side wall of the inner shell cavity; the first clamping part is clamped with the second clamping part; a plurality of limiting grooves are formed side by side on the upper side wall and/or lower side wall of the inner shell cavity; and each first wiring terminal is correspondingly assembled in the limiting groove.

Further, one side of the first housing is open to form a groove structure; the groove structure is divided into a plurality of first mounting cavities; a side wall at one end of the first housing is provided with a first socket, and a side wall at the other end of the first housing is provided with a first wiring hole; both ends of each first mounting cavity are communicated with the first socket and the first wiring hole respectively; the first wiring member comprises a first conductive plate and a first plug-in part; one end of the first conductive plate serving as a first wiring terminal is provided with a first wiring hole; the middle part of the first conductive plate is bent along a step surface and is limited in a first gap; the other end of the first conductive plate is connected to the first plug-in part; the first plug-in part comprises two elastic clamping arms, one ends of which are connected, and the other ends of which are arranged oppositely, and a clamping gap is reserved between the two elastic clamping arms.

Further, the static wiring assembly comprises a pair of cooperation parts; a static wiring base is arranged between the pair of cooperation parts; the static wiring base comprises a plurality of second wiring terminals arranged side by side; each second wiring terminal comprises a second housing and at least one second wiring member; the second housing is provided with at least one second socket and at least one second wiring hole; the second wiring member is assembled in the second housing, and both ends of the second wiring member correspond to the second socket and the second wiring hole respectively; two adjacent second housings are spliced together; a positioning part is arranged on one side of each second housing in a protruding manner; and the positioning part can extend into the adjacent second housing for limiting the second wiring member.

Further, a recessed area is arranged in the middle of one end surface of the second housing; the second housing on one side of the recessed area serves as a second plug-in part; an end wall of the second plug-in part is provided with a second socket; the second housing on the other side of the recessed area serves as a second wiring part; and a side wall on one side of the second wiring part away from the recessed area is provided with a second wiring hole, so that the wiring direction of the second wiring hole forms a certain included angle with the wiring direction of the second socket.

Further, also comprising a cover plate, wherein one end of the cover plate is rotatably connected to the base, and the other end of the cover plate is in buckling connection with the base, covering one end of the base cavity,

According to the secondary wiring device of the present invention, the locking mechanism is arranged between the moving part and the base; a first locking assembly of the locking mechanism locks the moving part in a base cavity, and the moving part can move in the base cavity after unlocking; a rotating member of the first locking assembly is pushed by a static wiring assembly to unlock and rotate; and a sliding member is driven by the rotating member, achieving the advantages of simple structure, high reliability and convenience in operation.

In addition, the rotating member and the sliding member cooperate with a first elastic member and a second elastic member respectively, and the first elastic member and the second elastic member provide a reset force, which is conducive to making the rotating member and the sliding member return to original positions.

In addition, the locking mechanism includes a second locking assembly. After the first locking assembly is unlocked, the moving part is limited by the second locking assembly from moving out of the base cavity, so that the stability of the cooperation between the moving part and the base is further guaranteed.

In addition, in the moving wiring assembly of the secondary wiring device, a plurality of first wiring terminals is assembled in an inner shell cavity of the moving part, the plurality of first wiring terminals is assembled with each other through their respective first housings, and each first housing is clamped with the inner shell cavity, so that each first wiring terminal is conveniently mounted into the inner shell cavity, achieving the advantage of convenience in disassembly and assembly.

In addition, a plurality of limiting grooves are formed side by side on the inner shell cavity, so that each first wiring terminal is conveniently assembled in the inner shell cavity, which ensures the mounting stability.

In addition, in the static wiring assembly of the secondary wiring device, a static wiring base includes a plurality of spliced second wiring terminals, wherein the plurality of second wiring terminals is spliced with each other through their respective second housings, and each second housing is provided with a positioning part that may extend into the adjacent second housing in order to limit the position of an adjacent second wiring member, achieving the advantages of convenience in disassembly and stable connection.

In addition, a wiring direction of a second wiring hole is at a certain angle with a wiring direction of a second socket, which is convenient for wiring.

In addition, a cover plate that covers one end of the base cavity is connected to the base and further provides a stable motion environment for the moving part. In particular, the cover plate is rotatably connected to one end of the base, and the other end of the base is connected via a buckle, achieving the advantage of convenience in disassembly.

### BRIEF DESCRIPTION OF THE DRAWINGS

FIG. 1 is a schematic structural diagram of a secondary wiring device and a drawer base in the present invention;

FIG. 2 is a schematic structural diagram of the secondary wiring device in the present invention (a first locking assembly is in a locked state);

FIG. 3 is a schematic diagram of the cooperation between a static wiring assembly and a first locking assembly in the present invention (in a locked state);

FIG. 4 is a schematic diagram of the cooperation between the static wiring assembly and the first locking assembly in the present invention (in an unlocked state);

FIG. 5 is a schematic structural diagram of a moving wiring assembly and a locking mechanism in the present invention;

FIG. 6 is a schematic structural diagram of the moving wiring assembly in the present invention;

FIG. 7 is a schematic structural diagram of a sliding cavity, a sliding member and the moving wiring assembly in the present invention;

FIG. 8 is a schematic structural diagram of the sliding cavity, the sliding member, the first wiring terminal and a moving part in the present invention;

FIG. 9 is a schematic structural diagram of the moving part, a rotating member and a first limiting part in the present invention;

FIG. 10 is a schematic structural diagram of an inner shell in the present invention (at one end close to the static wiring assembly);

FIG. 11 is a schematic structural diagram of the inner shell in the present invention (at one end away from the static wiring assembly);

FIG. 12 is a schematic structural diagram of a base and the sliding member in the present invention;

FIG. 13 is a schematic structural diagram of the base in the present invention (at one end away from the static wiring assembly);

FIG. 14 is a schematic structural diagram of the base in the present invention (at one end close to the static wiring assembly);

FIG. 15 is a schematic structural diagram of a cover plate in the present invention;

FIG. 16 is a schematic structural diagram of the rotating member in the present invention;

FIG. 17 is a schematic structural diagram of the sliding member in the present invention;

FIG. 18 is a schematic structural diagram of the first wiring terminal in the present invention;

FIG. 19 is a schematic structural diagram of a first housing in the present invention.

FIG. 20 is a schematic structural diagram of a first wiring member in the present invention;

FIG. 21 is a schematic diagram of the wiring between the first wiring member and a second wiring member in the present invention;

FIG. 22 is a schematic structural diagram of the static wiring assembly in the present invention;

FIG. 23 is a schematic structural diagram of a second wiring terminal in the present invention;

FIG. 24 is a schematic structural diagram of a second housing in the present invention (a side where a groove structure is formed);

FIG. 25 is a schematic structural diagram of the second housing in the present invention (a side where a positioning part is provided);

FIG. 26 is a schematic structural diagram of a cooperation part in the present invention; and

FIG. 27 is a schematic structural diagram of a guide rail 23 in the present invention.

Reference symbols represent the following components: 1—moving wiring assembly; 11—base; 111—base cavity; 112—clamping groove; 113—rotating shaft; 12—moving part; 121—inner shell; 1211—inner shell cavity; 1212—second clamping part; 1213—limiting groove; 122—first wiring terminal; 1221—first housing; 1221a—first gap; 1221b—first socket; 1221c—first wiring hole; 1221d—fixing part; 1222—first clamping part; 1223—first wiring member; 1223a—first conductive plate; 1223b—first plug-in part; 131—first limiting part; 1311—guide part; 132—rotating member; 1321—first rotating arm; 1322—second rotating arm; 133—sliding member; 1331—boss; 1332—assembling hole; 134—first elastic member; 135—second elastic member; 136—first connecting shaft; 137—abutting part; 138—sliding cavity; 1381—closing plate; 1391—second limiting part; 1392—third limiting part; 14—cover plate; 141—second buckle; 142—rotating shaft connecting groove; and

2—static wiring assembly; 21—cooperation part; 211—cooperation surface; 212—guide hole; 213—first fixing hole; 22—static wiring base; 221—second wiring terminal; 222—second housing; 2221—positioning part; 2222a—splicing boss; 2222b—splicing groove; 2223—recessed area; 2224—second plug-in part; 2225—second wiring part; 2226—second socket; 2227—second wiring hole; 2228a—straight cavity; 2228b—second gap; 2228c—accommodating cavity; 2228d—fixing boss; 223—second wiring member; 2231—second conductive plate; 2232—spring plate; 23—guide rail; and 231—second fixing hole.

### DETAILED DESCRIPTION OF THE INVENTION

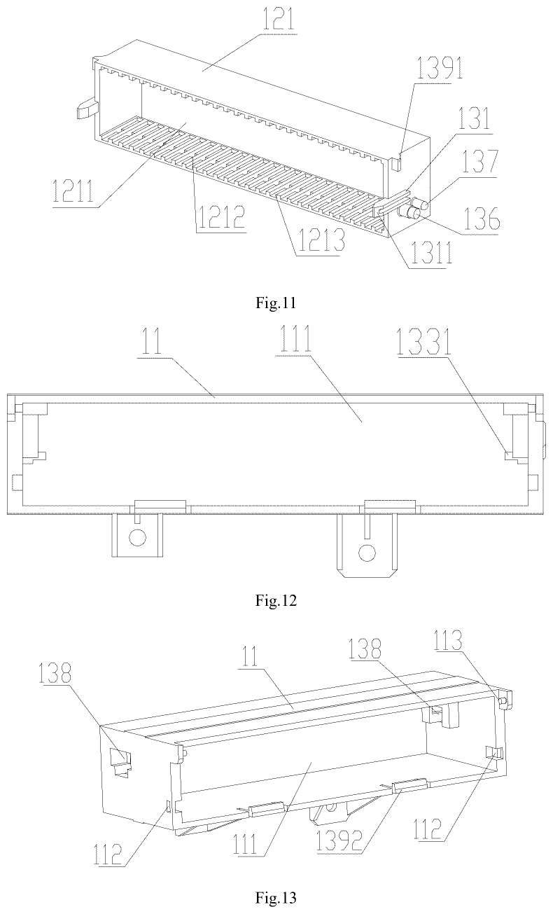

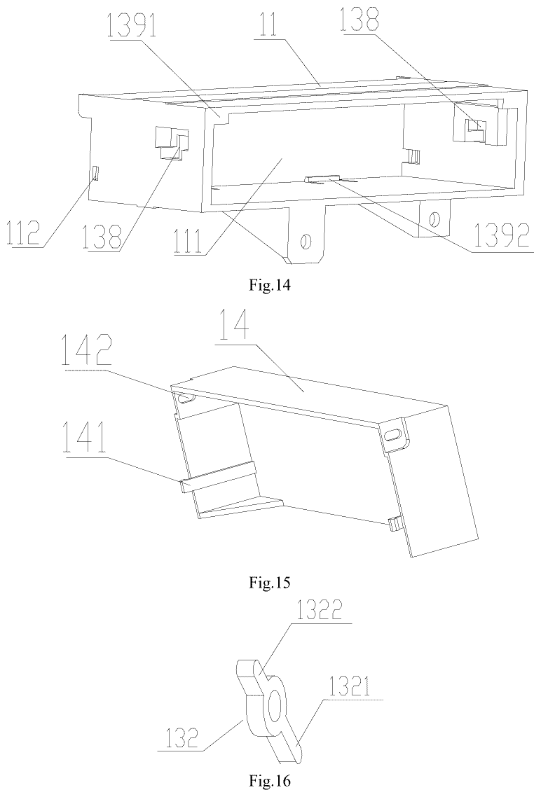

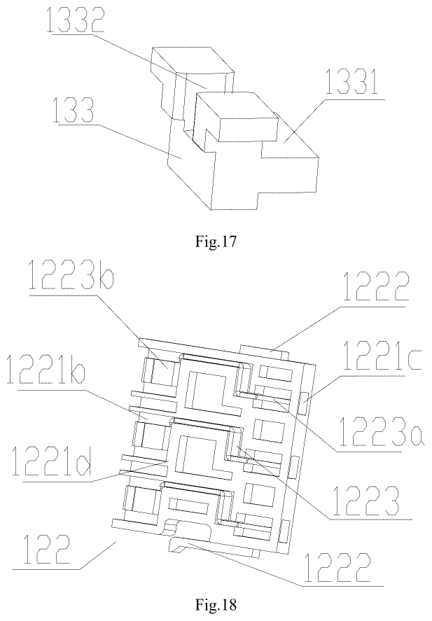

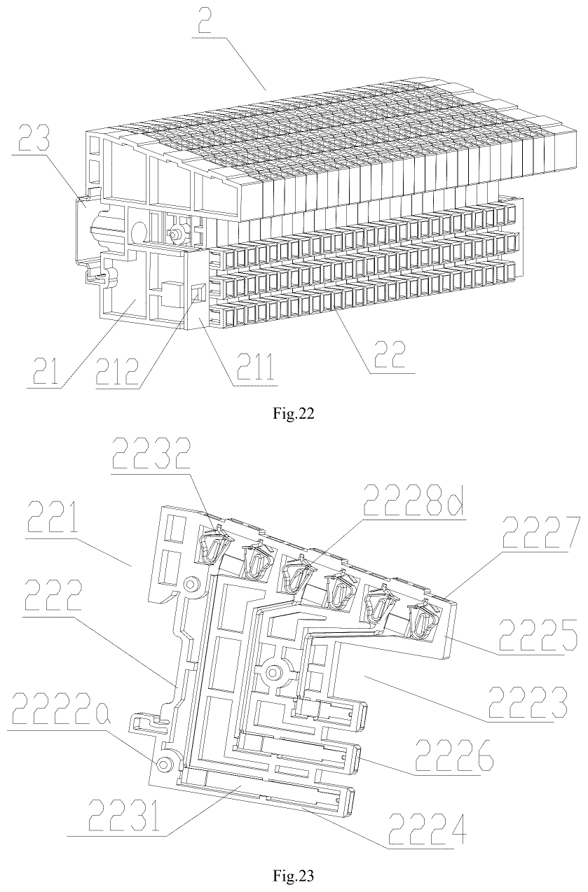

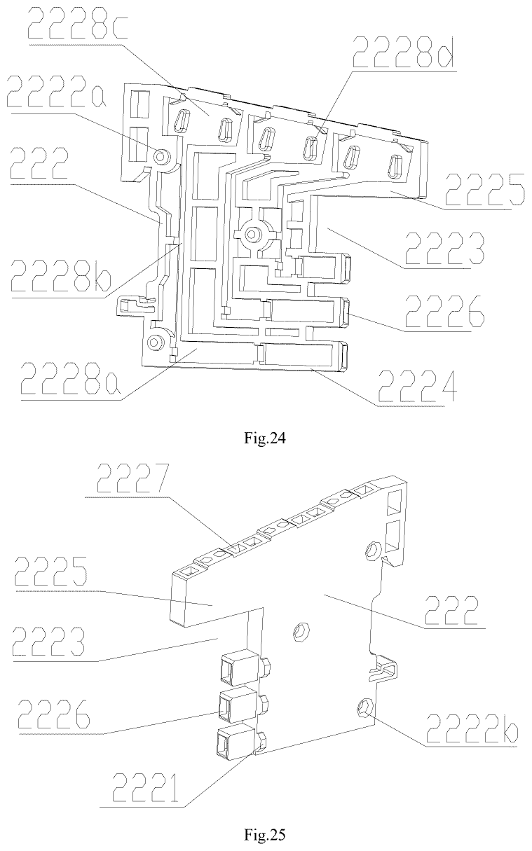

The specific implementation of a secondary wiring device of the present invention will be further described below with reference to the embodiments given in FIGS. 1-27. The secondary wiring device of the present invention is not limited to the description of the following embodiments.

As shown in FIG. 1, the secondary wiring device includes a moving wiring assembly 1 and a static wiring assembly 2. The moving wiring assembly 1 is provided with a first wiring terminal 122. The static wiring assembly 2 is provided with a second wiring terminal 221 that is in plug-in fit with the first wiring terminal 122. The moving wiring assembly 1 is pushed and pulled to move, such that the moving wiring assembly 1 is switched among a connection position, a test position and a disconnection position, wherein the test position is located between the connection position and the disconnection position. At the connection position or the test position, a wiring terminal of the moving wiring assembly 1 cooperates with a wiring terminal of the static wiring assembly 2 to realize an electrical connection; and at the disconnection position, the wiring terminal of the moving wiring assembly 1 and the wiring terminal of the static wiring assembly 2 are separated and powered off. The secondary wiring device is generally used for a drawer-type circuit breaker. The static wiring assembly 2 is arranged on a drawer base, and the moving wiring assembly 1 is arranged on a circuit breaker body. As the circuit breaker body is switched among the disconnection position, the test position and the connection position sequentially, the first wiring terminal 122 is separated from the second wiring terminal 221 at the disconnection position. The first wiring terminal 122 is in electrical contact connection with the second wiring terminal 221 at the test position. The first wiring terminal 122 keeps in electrical contact connection with the second wiring terminal 221 at the connection position. The test position and the connection position may also be generally referred to as a first connection position and a second connection position.

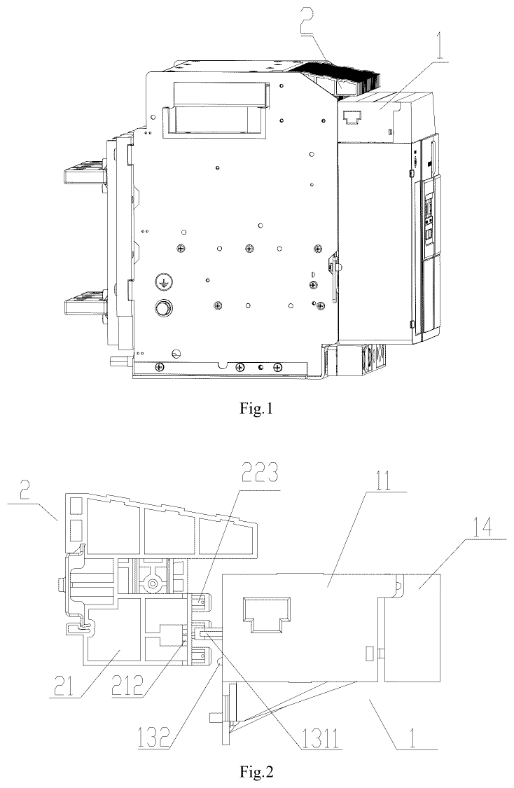

As shown in FIGS. 2-14, the moving wiring assembly 1 includes a base 11 and a moving part 12 assembled in the base cavity 111, wherein the moving part 12 includes an inner shell 121 and a plurality of first wiring terminals 122 assembled side by side in an inner shell cavity 121, and each first wiring terminal 122 includes a conductive first wiring member 1223. As shown in FIGS. 2-4 and 22-26, the static wiring assembly 2 includes a pair of cooperation parts 21, wherein a static wiring base 22 is arranged between the pair of cooperation parts 21. The static wiring base 22 includes a plurality of second wiring terminals 221 arranged side by side, wherein each second wiring terminal 221 includes a second wiring member 223 in cooperative contact with the first wiring member 1223 of the first wiring terminal 122. When the secondary wiring device is in the connection position or the test position, the first wiring terminal 122 is in contact with the second wiring terminal 221 to realize an electrical connection. When the secondary wiring device is in the disconnection position, the first wiring terminal 122 is separated from the second wiring terminal 221.

The present application has the following improvement point in that: the locking mechanism is arranged between the moving part 12 and the base 11; the locking mechanism includes a first locking assembly; at the test position or the disconnection position, the moving part 12 is locked in the base cavity 111 by the first locking assembly; at the connection position, the first locking assembly after unlocking makes the moving part 12 move in the base cavity 111, which ensures that the moving part 12 may be in limiting fit with the base 11 and also slide relative to the base 11, so that the moving part 12 slides relative to the base 11 as the base 11 moves from the test position to the connection position with the circuit breaker body. However, the wiring terminal is static relative to the static wiring assembly 2, such that the first wiring terminals 122 are respectively in contact with the second wiring terminals 221 to realize an electrical connection at the test position and the connection position.

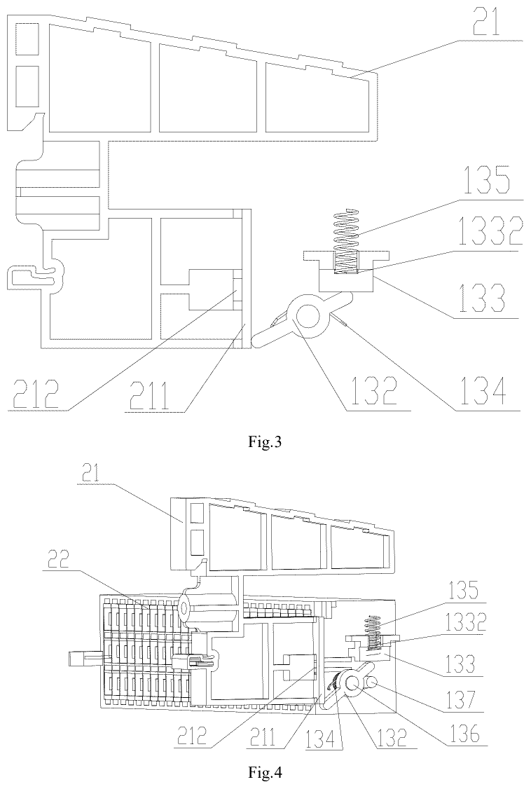

Specifically, as shown in FIGS. 3-5, and 7-12, the first locking assembly 1ncludes a first limiting part 131, a rotating member 132 and a sliding member 133. The first limiting part 131 is fixedly arranged on the moving part 12. The sliding member 133 is slidably assembled on the base 11 and is in limiting fit with the first limiting part 131. The rotating member 132 is rotatably assembled between the moving part 12 and the base 11. When the moving wiring assembly 1 moves from the test position to the connection position, the static wiring assembly 2 drives the rotating member 132 to unlock and rotate. The sliding member 133 is driven by the rotating member 132 to slide in a direction away from the first limiting part 131 so as to release the limiting fit from the first limiting part 131, so that the moving part 12 moves in the base cavity 111. The rotating member 132 is pushed by the static wiring assembly 2 to unlock and rotate. The sliding member 133 is driven by the rotating member 132, so that the first locking assembly is unlocked, achieving the advantages of simple structure, high reliability and convenience in operation.

Further, the locking mechanism further includes a second locking assembly. The second locking assembly is arranged on a side of the base cavity 111 and/or a side of the moving part 12. After the first locking assembly is unlocked, the second locking assembly limits the moving part 12 from moving out of the base cavity 111.

Further, the base 11 is equipped with a detachable cover plate 14. The cover plate 14 covers the base cavity 111 at one end away from the static wiring assembly 2. Preferably, the cover plate 14 is rotatably connected to the base 11. That is, one end of the cover plate 14 is rotatably connected to the base 11, and the other end of the cover plate 14 is in buckling connection with the base 11, achieving the advantage of convenience in disassembly.

The present application further has the following improvement point in that: a structure convenient for disassembly and assembly is adopted for the moving wiring assembly 1 and the static wiring assembly 2 that are in plug-in fit with each other, wherein a plurality of first wiring terminals 122 in the moving wiring assembly 1 is spliced together through their respective first housings 1221s, and each first wiring terminal 122 is clamped with the inner shell cavity 1211 respectively; a plurality of second wiring terminals 221 in the static wiring assembly 2 may also be spliced; in addition, a positioning part 2221 is arranged on the second housing 222 of the second wiring terminal 221, and the positioning part 2221 extends into the second housing 222 of the adjacent second wiring terminal 221 to limit the second wiring member 223, which not only ensures the convenience in disassembly and assembly of the static wiring assembly 2 but also further guarantees the mounting stability of the second wiring terminal 223, and is conducive to ensuring the plug-in stability of the moving wiring assembly 1 and the static wiring assembly 2.

Preferably, guide structures which cooperate with each other are also arranged between the moving wiring assembly 1 and the static wiring assembly 2. Each guide structure includes a guide part 1311 and a guide hole 212. As the moving wiring assembly 1 is pushed and pulled, the guide part 1311 is in plug-in fit with the guide hole 212.

A specific embodiment of a second wiring device is provided in conjunction with FIGS. 1-27. The secondary wiring device includes a moving wiring assembly 1 and a static wiring assembly 2 that are in plug-in fit with each other. As shown in FIG. 1, the static wiring assembly 2 is fixedly assembled on the upper part of a drawer base, and the moving wiring assembly 1 is in sliding fit with the drawer base. The moving wiring assembly 1 is pushed and pulled to be switched among a connection position, a test position and a disconnection position. In the drawings, the moving wiring assembly 1 is pushed, such that the moving wiring assembly 1 passes through the disconnection position and the test position in sequence and arrives at the connection position. At the connection position or the test position, the first wiring terminal 122 of the moving wiring assembly 1 cooperates with the second wiring terminal 221 of the static wiring assembly 2, and the first wiring member 1223 of the first wiring terminal 122 is in plug-in fit or in contact with the second wiring member 223 of the second wiring terminal 221 at this moment, thereby ensuring that a secondary circuit is energized and achieving normal operation or detection. At the disconnection position, the first wiring member 1223 is separated from the second wiring member 223, so that the secondary circuit is disconnected.

As shown in FIGS. 2-14, the moving wiring assembly 1 includes a base 11. The base 11 is provided with a base cavity 111, both ends of which are open. A moving part 12 is slidably assembled in the base cavity 111. A locking mechanism is arranged between the base cavity 111 and the moving part 12. Preferably, the locking mechanism is symmetrically arranged in a gap between the base cavity 111 and the moving part 12. The locking mechanism includes a first locking assembly. The moving part 12 is locked in the base cavity 111 by the first locking assembly. After unlocking, the first locking assembly causes the moving part 12 to move in the base cavity 111. That is, the moving part 12 moves in the base cavity 111 in a direction away from the static wiring assembly 2. Preferably, the first locking assemblies are arranged in pairs and are located at one end of the moving wiring assembly 1 close to the static wiring assembly 2.

An embodiment of the first locking assembly is provided in conjunction with FIGS. 2-14. The first locking assembly 1ncludes a first limiting part 131, a first elastic member 134, a rotating member 132, a sliding member 133 and a second elastic member 135. The first elastic member 134 cooperates with the rotating member 132 to provide a reset force for the rotating member 132. The second elastic member 135 cooperates with the sliding member 133 to provide a reset force for the sliding member 133. The first limiting part 131 is fixedly arranged on the moving part 12. The sliding member 133 is slidably assembled on the base 11 and is in limiting fit with the first limiting part 131. The rotating member 132 is rotatably assembled between the moving part 12 and the base 11. When the moving wiring assembly 1 is driven to move from the test position to the connection position, the rotating member 132 is driven by the static wiring assembly 2 to unlock and rotate. A first rotating arm 1321 of the rotating member 132 may preferably have a part extending out of the base cavity 111 for cooperating with the static wiring assembly 2. Of course, when the static wiring assembly 2 may extend into a gap between the moving part 12 and the base cavity 111, the first rotating arm 1321 of the rotating member 132 may also be completely located in the base cavity 111, and the sliding member 133 is driven by the rotating member 132 to slide in a direction away from the first limiting part 131.

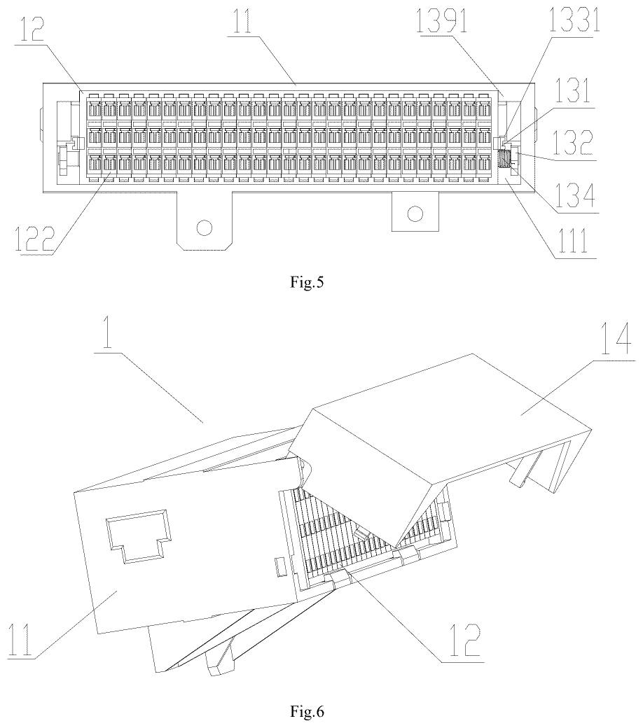

As shown in FIGS. 5. and 8-11, the first limiting part 131 is a strip-shaped boss that is arranged on the moving part 12 in a protruding manner. The central axis of the first limiting part 131 is parallel to a moving direction of the moving wiring assembly 1. The rotating member 132 and the sliding member 133 are positioned on both sides of the first limiting part 131 respectively. The sliding member 133 performs linear reciprocating motion in a direction perpendicular to of the central axis of the first limiting part 131. Of course, the first limiting part 131 may also be arranged in a groove of the moving part 12, and the sliding member 133 may slide into the groove from an opening of the groove, is locked when the sliding member 133 abuts against the bottom of the groove, and is unlocked after the sliding member 133 is separated from the bottom of the groove.

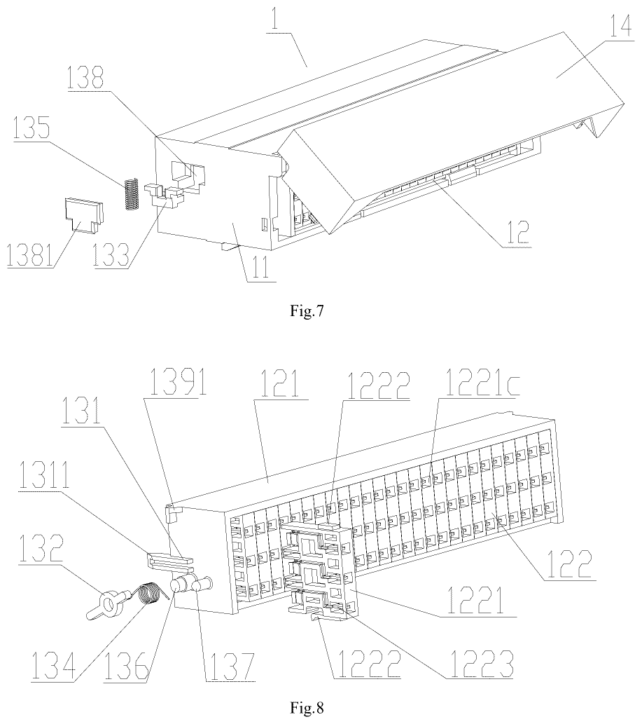

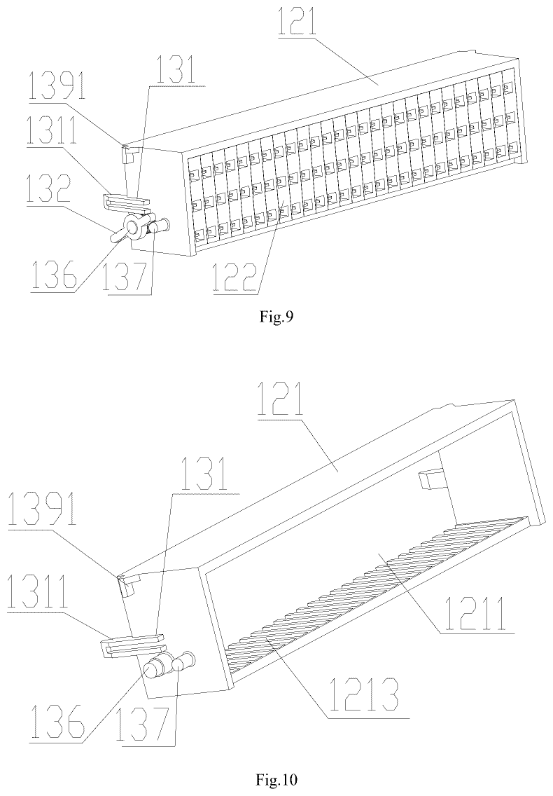

Preferably, as shown in FIG. 4, the rotating member 132 and the sliding member 133 are respectively located on upper and lower sides of the first limiting part 131, a first connecting shaft 136 and an abutting part 137 are arranged below the first limiting part 131 in a protruding manner, and a side wall of the base cavity 111 is provided with a sliding cavity 138 in which the sliding member 133 is assembled. As shown in FIGS. 7, 13 and 14, the sliding cavity 138 is a groove that penetrates through the side wall of the base 11, the outer side of the sliding cavity 138 is closed by a closing plate 1381, the sliding cavity 138 provides a sliding space for the sliding member 133, and the sliding cavity 138 corresponds to the upper side of the first limiting part 131. As shown in FIGS. 9 and 16, a shaft hole is formed in the middle of the rotating member 132, and a first rotating arm 1321 and a second rotating arm 1322 of the rotating member 132 extend in two opposite directions respectively, wherein the first rotating arm 1321 has a length greater than that of the second rotating arm 1322, the rotating member 132 and a torsion spring as the first elastic member 134 jointly are sleeved onto the first connecting shaft 136, wherein one elastic arm of the first elastic member 134 abuts against the abutting part 137. In this embodiment, as shown in FIG. 4, the second rotating arm 1322 of the rotating member 132 is located between the abutting part 137 and the first limiting part 131 for pushing the sliding member 133. In this way, one elastic arm of the first elastic member 134 abuts against the lower side of the abutting part 137, the other elastic arm of the first elastic member 134 is opposite to the upper side of the first rotating arm 1321 of the rotating member 132, and when the first locking assembly is in a locked state, the first rotating arm 1321 of the rotating member 132 is inclined downward, and the second rotating arm 1322 is inclined upward.

As shown in FIGS. 4, 12, and 17, the sliding member 133 is block-shaped as a whole. An assembling hole 1332 is formed in the middle of the sliding member 133. A second elastic member 135 is mounted in the assembling hole 1332. Both ends of the second elastic member 135 abut against the assembling hole 1332 and the sliding cavity 138 respectively. A boss 1331 is arranged on one side of the sliding member 133 in a protruding manner. A bottom surface of the boss 1331 may abut against one side of the first limiting part 131. Preferably, a bottom surface of one side of the boss 1331 is a step surface. The step surface abuts against the first limiting part 131. At this time, the second elastic member 135 provides an elastic force for the sliding member 133, so that the sliding member 133 keeps abutting against the first limiting part 131, thereby locking the moving part 12. When the rotating member 132 is driven to rotate in an unlocking direction, the first elastic member 134 stores energy for providing a reset force for the rotating member 132. The sliding member 133 is driven to slide upward and is separated from the first limiting part 131, in order to avoid the first limiting part 131. The second elastic member 135 stores energy for providing a reset force for the second elastic member 135, such that the first locking assembly is unlocked, and the moving part 12 may slide relative to the base 11. It should be noted that when the mass of the sliding member 133 is large enough, the second elastic member 135 and the abutting part 137 can be omitted, and the sliding member 133 abuts against the first limiting part 131 under the action of gravity to keep the locked state.

As another embodiment of the first unlocking assembly (not shown), the first locking assembly is not provided with a first elastic member 134 and a second elastic member 135. Correspondingly, the abutting part 137 may also be omitted. At this moment, the first rotating arm 1321 of the rotating member 132 is used for cooperating with the static wiring assembly 2, and the second rotating arm 1322 of the rotating member 132 is in linkage with the sliding member 133. The sliding member 133 is located above the first limiting part 131 and the rotating member 132, and the rotating member 132 may be located below or above the first limiting part 131. After the static wiring assembly 2 drives the rotating member 132 to rotate in an unlocking direction in order to drive the sliding member 133 to slide in a direction away from the first limiting part 131, and the static wiring assembly 2 is separated from the first rotating arm 1321 of the rotating member 132, the sliding member 133 may be reset under the action of gravity, and the first elastic member 134 may drive the rotating member 132 to reset.

In this embodiment, as shown in FIGS. 5, and 8-11, the locking mechanism further includes a second locking assembly. The second locking assembly 1ncludes a second limiting part 1391 and a third limiting part 1392. The base cavity 111 and the moving part 12 are each provided with the second limiting part 1391. In the drawings, the second limiting part 1391 is a boss structure which is arranged in a protruding cavity, the second limiting part 1391 arranged on the base 11 is located at one end of the base cavity 111 close to the static wiring assembly 2, the second limiting part 1391 arranged on the moving part 12 is located at one end close to the static wiring assembly 2, and the second limiting part 1391 of the base 11 and the second limiting part 1391 of the moving part 12 may be mutually limited, so as to prevent the moving part 12 from sliding out from one end of the base cavity 111. In this embodiment, the second limiting part 1391 and the moving wiring assembly 1 are located at the same end of the moving wiring assembly 1, that is, one end of the moving wiring assembly 1 that is plugged with the static wiring assembly 2; and the third limiting part 1392 is arranged on a boss structure of the base cavity 111. In the drawings, the third limiting part 1392 is arranged on one side of the base cavity 111 away from the second limiting part 1391 to prevent the moving part 12 from sliding out from the other end of the base cavity 111. In this way, after the first locking assembly is unlocked, the second locking assembly prevents the moving part 12 from escaping from the base cavity 111, and it can also be considered that the second limiting part 1391 and the third limiting part 1392 limit a movement range of the moving part 12 in the base 11.

As shown in FIGS. 6 and 7, a cover plate 14 is rotatably connected to one end of the base 11 away from the static wiring assembly 2. In the drawings, the upper end of the cover plate 14 is provided with a rotating shaft connecting groove 142, and a rotating shaft that extends into the rotating shaft connecting groove 142 is cooperatively arranged on the side wall of the base cavity 111 in a protruding manner. In the drawings, the rotating shaft is located at one end of the base cavity 111 away from the static wiring assembly 2; a second buckle 141 is arranged at the lower end of the cover plate 14, and the side wall of the base 11 is provided with a second clamping groove 112. The second buckle 141 cooperates with the second clamping groove 112, such that the cover plate 14 covers the base 11, thereby providing a stable working environment for the moving part 12. One end of the moving part 12 away from the static wiring assembly 2 is isolated from the outside, ensuring the safety of use.

One end of the moving part 12 close to the static wiring assembly 2 is in plug-in fit with the static wiring assembly 2. Preferably, a guide structure is arranged between the moving part 12 and the static wiring assembly 2. A protruding guide part 1311 may be arranged on the moving part 12. A guide hole 212 which is in plug-in fit with the guide part 1311 is formed in the static wiring assembly 2. The guide part 1311 may be a boss structure that is separately arranged on the moving part 12. In this embodiment, as shown in FIGS. 8-11, the first limiting part 131 preferably extends outward, that is, one end of the first limiting part 131 facing the static wiring assembly 2 extends outward to form the guide part 1311.

As shown in FIGS. 7-11, the moving part 12 includes an inner shell 121. A plurality of first wiring terminals 122 is assembled side by side in the inner shell cavity 1211. Each first wiring terminal 122 includes a first housing 1221 and at least one first wiring member 1223. Each first housing 1221 is clamped into the inner shell cavity 1211. The two adjacent first wiring terminals 122 are spliced through the first housing 1221. The first wiring member 1223 is assembled in the first housing 1221 in a limiting manner, and both ends of the first wiring member 1223 may pass through the first housing 1221. That is, one end of the first wiring member 1223 is in plug-in fit with the static wiring assembly 2, and the other end of the first wiring member 1223 is used for wiring.

Preferably, an upper side wall and/or lower side wall of the inner shell cavity 1211 is provided with a plurality of limiting grooves 1213 arranged side by side. Each first wiring terminal 122 is correspondingly assembled in a limiting groove 1213. A first clamping part 1222 is arranged on the upper side and/or lower side of each first housing 1221. The first clamping part 1222 may be a buckle and/or a clamping platform. An upper side wall and/or lower side wall of the inner shell cavity 1211 is correspondingly provided with a second clamping part 1212. The second clamping part 1212 is a clamping groove, wherein the clamping groove may be formed in the limiting groove 1213. That is, the bottom of a part of the limiting groove 1213 is further recessed to form a clamping groove; or, a partial area of the limiting groove 1213 may also be used as the clamping groove directly. The first clamping part 1222 is clamped with the second clamping part 1212, so that each first wiring terminal 122 is clamped into the inner shell cavity 1211.

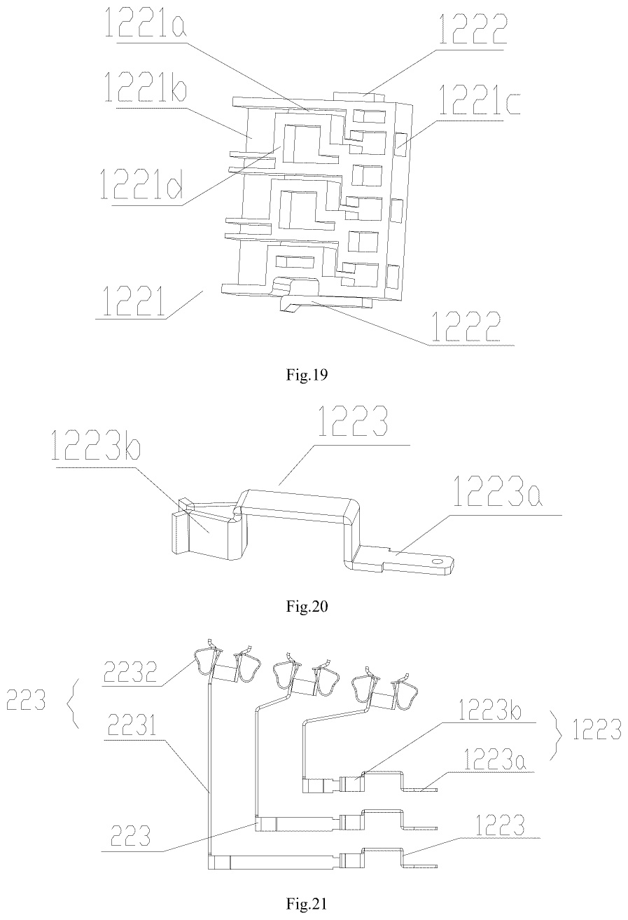

As shown in FIGS. 18 and 19, in this embodiment, the first clamping part 1222 is respectively arranged on lower and lower sides of the first housing 1221, wherein the first clamping part 1222 located on the upper side of the first housing 1221 is a clamping platform, and the first clamping part 1222 located on the lower side of the first housing 1221 is a buckle. A plurality of limiting grooves 1213 are respectively formed side by side on upper and lower sides of the inner shell cavity 1211, wherein a clamping groove (i.e . . . the second clamping part 1212) is formed in the middle of the limiting groove 1213 on the lower side is in plug-in fit with the first clamping part 1222 in the form of a buckle, and the limiting groove 1213 located on the upper side of the inner shell cavity 1211 may cooperate with the first clamping part 1222 in the form of a clamping platform.

As shown in FIGS. 18 and 19, one side of the first housing 1221 is open to form a groove structure, and the other side of the first housing 1221 is a bottom plate, which may be used to seal the groove structure of the adjacent first housing 1221. The groove structure is divided into a plurality of first mounting cavities, and a first wiring member 1223 is assembled in each first mounting cavity. A side wall of one end of the first housing 1221 is provided with a first socket 1221b, and a side wall of the outer end of the first housing 1221 is provided with a first wiring hole 1221c. Both ends of each first mounting cavity are communicated with the first socket 1221b and the first wiring hole 1221c respectively. Preferably, a fixing part 1221d is arranged in a first mounting cavity between the first socket 1221b and the first wiring hole 1221c, wherein the middle part of the fixing part 1221d may be hollow, so as to reduce the weight of the first housing 1221. One side of the fixing part 1221d is a step surface, and the step surface is formed in cooperation with a side wall of the first mounting cavity to clamp the first gap 1221a, so that the middle part of the first wiring member 1223 is limited in the first gap 1221a, so as to ensure that the first wiring member 1223 is stably assembled in the first mounting cavity. A first plug-in part 1223b of the first wiring member 1223 correspondingly extends out of the first socket 1221b for being in plug-in fit with the static wiring assembly 2, and a first wiring terminal of the first wiring member 1223 extends out of the first wiring hole 1221c for wiring. In this embodiment, the groove structure of the first housing 1221 is divided into three first mounting cavities, wherein the side wall of one end of the first housing 1221 is provided with three first sockets 1221b arranged side by side, and the side wall of the other end of the first housing 1221 is provided with three first wiring holes 1221c arranged side by side.

A structure applicable to the first wiring member 1223 in this embodiment is provided in conjunction with FIGS. 18, 20 and 21. The first wiring member 1223 includes a first conductive plate 1223a and a first plug-in part 1223b. Preferably, the first conductive plate 1223a and the first plug-in part 1223b are integrally formed, and one end of the first conductive plate 1223a as the first wiring terminal is provided with a threading hole. When the first wiring member 1223 is assembled in a first mounting cavity, the first wiring terminal may penetrate out of the first wiring hole 1221c. The middle part of the first conductive plate 1223a is bent, so that the first conductive plate 1223a is a Z-shape as a whole. The middle part of the first conductive plate 1223a is bent along the step surface of the fixing part 1221d and is limited in the first gap 1221a, and the other end of first conductive plate 1223a is connected to the first plug-in part 1223b. The first plug-in part 1223b may cooperatively pass through the first socket 1221b and be in plug-in fit with the static wiring assembly 2. The first plug-in part 1223b includes two elastic clamping arms, one ends of which are connected, and the other ends of which are opposite to each other, and a clamping gap is reserved between the two elastic clamping arms.

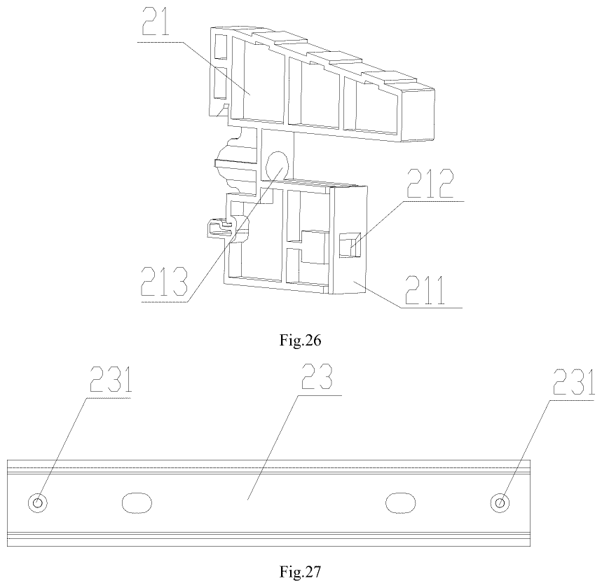

As shown in FIGS. 1-4. and 22-27, the static wiring assembly 2 in this embodiment includes a pair of cooperation parts 21. In this embodiment, when the moving wiring assembly 1 is in plug-in fit with the static wiring assembly 2, the first locking assembly is pushed by the cooperation parts 21 to be unlocked. In the drawings, one end surface of each cooperation part 21 facing the moving wiring assembly 1 is a cooperation surface 211 which is provided with a guide hole 212. When the moving wiring assembly 1 is in plug-in fit with the static wiring assembly 2, the guide part 1311 arranged on the moving part 12 is in plug-in fit with the guide hole 212. As shown in FIG. 26, a first fixing hole is formed in the middle of each cooperation part 21, and two first fixing holes 213 are symmetrically located on both sides of the static wiring assembly 2. Preferably, the central part of cooperation part 21 is recessed, so that the plane containing the first fixing hole 213 is lower than the plane containing the cooperation surface 211 is located.

A static wiring base 22 is arranged between the pair of cooperation parts 21. The static wiring base 22 includes a plurality of second wiring terminals 221 arranged side by side. Each second wiring terminal 221 includes a second housing 222 and at least one second wiring member 223. The second housing 222 is provided with at least one second socket 2226 and at least one second wiring hole 2227. The second wiring member 223 is assembled in the second housing 222, and both ends of the second wiring member 223 correspond to the second socket 2226 and the second wiring hole 2227 respectively. The central axis of the second wiring hole 2227 is parallel to the central axis of the guide hole 212. Preferably, an end surface of the second housing 222 which is provided with the second wiring hole 2227 protrudes out of the cooperation surface 211. Two adjacent second housings 222 are spliced together. A positioning part 2221 is arranged on one side of each second housing 222 in a protruding manner. The positioning part 2221 may extend into the adjacent second housing 222 for limiting the second wiring member 223. The positioning part 2221 may press the adjacent second wiring member 223, thereby ensuring the stability of assembly and use.

At least a group of splicing bosses 2222a and splicing grooves 2222b, which are in plug-in fit with each other is arranged between the adjacent two second housings 222. The protruding splicing bosses 2222a are arranged on the same side of all second housings 222, and the splicing grooves 2222b are correspondingly formed on the other sides of the second housings 222 facing away from the splicing bosses 2222a. Each cooperation part 21 is spliced together with the static wiring base 22. At least a group of splicing bosses 2222a and splicing grooves 2222b that are in plug-in fit with each other, is arranged between the cooperation part 21 and the adjacent second housing 222.

As shown in FIGS. 23-25, a recessed area 2223 is arranged in the middle of one end surface of the second housing 222. The second housing 222 on one side of the recessed area 2223 is used as the second plug-in part 2224. An end wall of the second plug-in part 2224 is provided with a second socket 2226. The second housing 222 on the other side of the recessed area 2223 is used as the second wiring part 2225. A side wall of one side of the second wiring part 2225 away from the recessed area 2223 is provided with a second wiring hole 2227. The end surfaces of the second plug-in parts 2224 are flush. The end surface of the second plug-in part 2224 is provided with a plurality of second sockets 2226 side by side. The second wiring part 2225 protrudes outward, so that the end surface of the second wiring part 2225 protrudes from the end surface of the second plug-in part 2224. A side wall of one side of the second wiring part 2225 away from the recessed area 2223 is an inclined side wall. The inclined side wall is provided with a plurality of second wiring holes 2227 side by side, and a wiring direction of the second wiring holes 2227 is at a certain angle with a wiring direction of the second socket 2226, so as to facilitate wiring. The recessed areas 2223 of all the second housings 222 are communicated to form a drawer avoiding groove in the middle of one end of the static wiring base 22 to avoid the moving wiring assembly 1. All second sockets 2226 and drawer avoiding grooves are located on the same side of the static wiring base 22. A guide rail 23 is fixed on the static wiring base 22 at one end away from the plug-in groove. The guide rail 23 is provided with a second fixing hole 231. As shown in FIG. 27, one second fixing hole 231 is respectively formed at both ends of the guide rail 23. Screws are assembled in the first fixing hole 213 and the second fixing hole 231, so that the guide rail 23 is fixedly connected to the cooperation part 21.

As shown in FIGS. 23-25, one side of each second housing 222 is open to form a groove structure. The groove structure is divided into a plurality of second mounting cavities. The second housing 222 on one side away from the groove structure is provided with a plurality of positioning parts 2221, and each positioning part 2221 correspondingly extends into the second mounting cavity of the adjacent second housing 222. In addition, a splicing boss 2222a is arranged on a side or in the middle of the groove structure in a protruding manner, and a splicing groove 2222b is formed in one side of the second housing 222 corresponding to the splicing boss 2222a. That is, the splicing groove 2222b and the positioning part 2221 are jointly located on one side of the second housing 222, and the shapes of the splicing boss 2222a and the positioning part 2221 are not specifically limited. The second mounting cavity includes a straight cavity 2228a, a second gap 2228b and an accommodating cavity 2228c. The straight cavity 2228a and the accommodating cavity 2228c are respectively located on both sides of the recessed area 2223. The accommodating cavity 2228c corresponds to the second wiring part 2225. The second wiring part 2225 that extends outward is conducive to increasing a capacity of the accommodating cavity 2228c. The straight cavity 2228a corresponds to the second plug-in part 2224. One end of the straight cavity 2228a corresponds to the second socket 2226. A positioning part 2221 is arranged on a side wall of the second housing 222 on one side away from the straight cavity 2228a in a protruding manner. The positioning part 2221 may correspondingly extend into the adjacent straight cavity 2228a. A side wall of the accommodating cavity 2228c is provided with a second wiring hole 2227. A fixing boss 2228d is arranged in the accommodating cavity 2228c in a protruding manner. The second gap 2228b is arranged in a direction perpendicular to the central axis of the second socket 2226 to communicate the straight cavity 2228a with the accommodating cavity 2228c. In this embodiment, three second mounting cavities are arranged side by side in the second housing 222, wherein one of the second mounting cavities is arranged around one side of the recessed area 2223, and the remaining two second mounting cavities are arranged side by side in sequence. The length of the second gap 2228b is adjusted by means of elongation or shortening, inclination, and other setting modes, so that both ends of the second wiring member 223 correspond to the second socket 2226 and the second wiring hole 2227 respectively.

A specific structure of the second wiring member 223 in this embodiment is provided in conjunction with FIGS. 21 and 23, the second wiring member 223 includes a second conductive plate 2231 and a spring plate 2232, wherein the middle part of the second conductive plate 2231 is twisted, so that a first end of the second conductive plate 2231 and a second end of the second conductive plate 2231 are not in the same plane. The first end of the second conductive plate 2231 is used as a second plug-in plate. The second plug-in plate may be plugged into a clamping gap between two elastic clamping arms in the first wiring plate. The spring plate 2232 is bent into an annular shape, and a connecting groove is formed in a plate surface of the spring plate 2232. The second end of the second conductive plate 2231 passes through the connecting groove and is in limiting fit with the spring plate 2232. Preferably, the second conductive plate 2231 includes a plurality of second ends connected side by side. A spring plate 2232 is respectively connected to the second end of each second conductive plate 2231. The plurality of spring plates 2232 is correspondingly assembled inside the second wiring part 2225. Each spring plate 2232 is mounted on the fixing boss 2228d of the accommodating cavity 2228c. The tail of the second end of each second conductive plate 2231 is bent to one side. In the drawings, when two spring plates 2232 are connected to the second end of the second conductive plate 2231, each spring plate 2232 corresponds to one second wiring hole 2227. That is, each second mounting cavity corresponds to two second wiring holes 2227 side by side, so that the side wall of each second housing 222 is provided with six side-by-side second wiring holes 2227.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. A secondary wiring device, comprising a moving wiring assembly and a static wiring assembly which are in plug-in connection with each other, wherein the moving wiring assembly is provided with a first wiring terminal; the static wiring assembly is provided with a second wiring terminal that is in plug-in fit with the first wiring terminal; the moving wiring assembly moves among a disconnection position, a test position and a connection position, wherein the test position is located between the connection position and the disconnection position; the first wiring terminal is separated from the second wiring terminal at the disconnection position; the first wiring terminal is in electrical contact connection with the second wiring terminal at the test position; the first wiring terminal is in electrical contact connection with the second wiring terminal at the connection position;
the dynamic wiring assembly comprises a base and a moving part that is slidably assembled in a base cavity; the first wiring terminal is arranged on the moving part; a locking mechanism is arranged between the base and the moving part; the locking mechanism includes a first locking assembly; the first locking assembly is used for locking the moving part in the base cavity; and
the first locking assembly comprises a first limiting part, a rotating member and a sliding member, wherein the first limiting part is fixedly arranged on the moving part; the sliding member is slidably assembled on the base and is in limiting fit with the first limiting part; the rotating member is rotatably assembled between the moving part and the base; when the moving wiring assembly moves from the test position to the connection position, the static wiring assembly drives the rotating member to unlock and rotate; and the sliding member is driven by the rotating member to slide in a direction away from the first limiting part so as to release the limiting fit, so that the moving part moves in the base cavity.

2. The secondary wiring device according to claim 1, wherein the central axis of the first limiting part is parallel to a moving direction of the moving wiring assembly, the rotating member and the sliding member are positioned on both sides of the first limiting part respectively, with the sliding member performing linear reciprocating motion in a direction perpendicular to the central axis of the first limiting part.

3. The secondary wiring device according to claim 1, wherein the first locking assembly further comprises a first elastic member and a second elastic member which cooperate with the rotating member and the sliding member respectively; when the moving wiring assembly moves from the connection position to the test position, the first elastic member drives the rotating member to lock and rotate, and the second elastic member drives the sliding member to slide toward the first limiting part.

4. The secondary wiring device according to claim 3, wherein a first connecting shaft and an abutting part are arranged on one side of the first limiting part in a protruding manner; the rotating member and the first elastic member are sleeved onto the first connecting shaft; one elastic arm of the first elastic member abuts against the abutting part, and the other elastic arm cooperates with the second connecting arm of the rotating member; and the first rotating arm of the rotating member cooperates with the sliding member.

5. The secondary wiring device according to claim 3, wherein a side wall of the base cavity is provided with a sliding cavity; the sliding member is slidably assembled in the sliding cavity; an assembling hole is formed in the middle of the sliding member with a second elastic member mounted inside the assembling hole; a boss is arranged on one side of the sliding member in a protruding manner; and the bottom surface of the boss may abut against one side of the first limiting part.

6. The secondary wiring device according to claim 1, wherein a guide structure is arranged between the moving part and the static wiring assembly; the guide structure comprises a guide part and a guide hole; and as the moving wiring assembly moves, the guide part is in plug-in fit with the guide hole.

7. The secondary wiring device according to claim 6, wherein one end of the first limiting part facing the static wiring assembly protrudes and extends outward to form the guide part; and the static wiring assembly is provided with the guide hole that cooperates with the guide part.

8. The secondary wiring device according to claim 1, wherein the locking mechanism further comprises a second locking assembly; the second locking assembly is arranged on a side of the base cavity and/or a side of the moving part; and after the first locking assembly is unlocked, the second locking assembly limits the moving part from moving out of the base cavity.

9. The secondary wiring device according to claim 1, wherein the moving part comprises an inner shell and a plurality of first wiring terminals assembled side by side in an inner shell cavity; a locking mechanism is arranged between the outer side of the inner shell and the base; the static wiring assembly comprises a pair of cooperation parts and a static wiring base arranged between the pair of cooperation parts; the static wiring base comprises a plurality of second wiring terminals arranged side by side; and at the connection position, the first wiring terminals are in plug-in connection with the second wiring terminals, and the rotating member is driven by the cooperation parts to unlock and rotate.

10. The secondary wiring device according to claim 1, wherein each first wiring terminal comprises a first housing and at least one first wiring member; each first housing is clamped into the inner shell cavity two adjacent first wiring terminals are spliced through the first housing; the first wiring member is assembled in the first housing in a limiting manner; and both ends of the first wiring member can pass through the first housing.

11. The secondary wiring device according to claim 10, wherein a first clamping part is arranged on the upper side and/or lower side of each first housing; a second clamping part is cooperatively arranged on an upper side wall and/or lower side wall of the inner shell cavity; the first clamping part is clamped with the second clamping part; a plurality of limiting grooves are formed side by side on the upper side wall and/or lower side wall of the inner shell cavity; and each first wiring terminal is correspondingly assembled in the limiting groove.

12. The secondary wiring device according to claim 10, wherein one side of the first housing is open to form a groove structure; the groove structure is divided into a plurality of first mounting cavities; a side wall at one end of the first housing is provided with a first socket, and a side wall at the other end of the first housing is provided with a first wiring hole; both ends of each first mounting cavity are communicated with the first socket and the first wiring hole respectively; the first wiring member comprises a first conductive plate and a first plug-in part; one end of the first conductive plate serving as a first wiring terminal is provided with a first wiring hole; the middle part of the first conductive plate is bent along a step surface and is limited in a first gap; the other end of the first conductive plate is connected to the first plug-in part; the first plug-in part comprises two elastic clamping arms, one ends of which are connected, and the other ends of which are arranged oppositely, and a clamping gap is reserved between the two elastic clamping arms.

13. The secondary wiring device according to claim 1, wherein the static wiring assembly comprises a pair of cooperation parts; a static wiring base is arranged between the pair of cooperation parts; the static wiring base comprises a plurality of second wiring terminals arranged side by side; each second wiring terminal comprises a second housing and at least one second wiring member; the second housing is provided with at least one second socket and at least one second wiring hole; the second wiring member is assembled in the second housing, and both ends of the second wiring member correspond to the second socket and the second wiring hole respectively; two adjacent second housings are spliced together; a positioning part is arranged on one side of each second housing in a protruding manner; and the positioning part can extend into the adjacent second housing for limiting the second wiring member.

14. The secondary wiring device according to claim 13, wherein a recessed area is arranged in the middle of one end surface of the second housing; the second housing on one side of the recessed area serves as a second plug-in part; an end wall of the second plug-in part is provided with a second socket; the second housing on the other side of the recessed area serves as a second wiring part; and a side wall on one side of the second wiring part away from the recessed area is provided with a second wiring hole, so that the wiring direction of the second wiring hole forms a certain included angle with the wiring direction of the second socket.

15. The secondary wiring device according to claim 1, further comprising a cover plate, wherein one end of the cover plate is rotatably connected to the base, and the other end of the cover plate is in buckling connection with the base, covering one end of the base cavity.
